(19) United States
(12) Patent Application Publication
(10) Pub. No.: US 2019/0335784 A1
(43) Pub. Date: Nov. 7, 2019

(54) ASSEMBLY LINE TECHNIQUE FOR FOOD PRODUCTION AND PULL-APART FOOD PRODUCT AND METHOD

(71) Applicant: ARYZTA LLC, Los Angeles, CA (US)

(72) Inventors: Nancy Kirksey, Corona Del Mar, CA (US); Scott Fitzgerald, Huntington Beach, CA (US)

(21) Appl. No.: 16/418,717

(22) Filed: May 21, 2019

Related U.S. Application Data
(63) Continuation of application No. 11/538,045, filed on Oct. 2, 2006, now abandoned.
Application No. 11/538,045 is a continuation-in-part of application No. 11/457,218, filed on Jul. 13, 2006, now abandoned.
(60) Provisional application No. 60/763,857, filed on Jan. 31, 2006.

(51) Int. Cl. A23G 3/22; B26D 7/08; A23G 7/00; A21C 9/04; A21C 11/10; A23G 1/20

(52) U.S. Cl. CPC A23G 3/22; B26D 7/086; A23G 1/205; A21C 9/04; A21C 11/10; A23G 7/0018

(57) ABSTRACT

An assembly line technique is described in which food items with a deposited layer of smear prior to baking can be cut and segregated into small pieces. The food pieces are deposited randomly into an ovenable serving container in such a way as to reduce contact between the smear coated surface(s) of the food pieces. This results in a “pull-apart” food product that can be rapidly microwave heated in the container and served in the container.

### CROSS-REFERENCE TO RELATED APPLICATIONS

This application is a continuation of U.S. patent application Ser. No. 11/538,045 filed Oct. 2, 2006 and entitled “Assembly Line Technique for Pull-Apart Food Production,” which is a continuation-in-part of U.S. patent application Ser. No. 11/457,218 filed Jul. 13, 2006 and entitled “Assembly Line Technique for Pull-Apart Food Production,” which claims priority to U.S. Provisional Patent Application Ser. No. 60/763,857 filed Jan. 31, 2006 and entitled “Assembly Line Technique for Pull-Apart Food Production,” which are hereby incorporated by reference herein.

### BACKGROUND OF THE INVENTION

### 1. Field of Invention

The present invention relates generally to the field of food production and more specifically, to an assembly line technique for cutting and segregating of sticky food. The present invention also relates to a food product and method of production.

### 2. Description of Related Art

There are many food items on the market which have inherent bulk stickiness or a sticky coating or layer. Food items with inherent bulk stickiness include, but are not restricted to, cheeses, cheesecakes, pies, and brownies. Food items with sticky coatings or layers include, but are not restricted to, cakes, cookies, donuts, and cinnamon rolls. Many of these food items are sold to the consumer in whole form requiring that the consumer cut and segregate individual servings of the food with a kitchen utensil such as a knife. Nowadays, these food items tend to be pre-sliced before they reach the customer.

In the case of a food item having a sticky component, the bakery or supplier typically utilizes a knife dipped in hot water or a wire under tension to cut, i.e., slice, whole food items into separate portions for individual consumption. The use of a thin narrow bladed knife or wire under tension is advantageous because a reduction in the contact area between the knife and the sticky material provides a relatively cleaner cut than in the case of a thicker, broader knife blade. Nevertheless, if the same knife or tensioned wire utensil is used repeatedly to cut or slice multiple same or similar food items, the sticky component of the food item accumulates on the utensil over time, thereby requiring the utensil to be cleaned in order to facilitate continued usage. Repeated cleaning of the utensil presents a problem in bakeries or food preparation settings where high output and/or high efficiency food production is desired.

In an attempt to circumvent such a problem, bakeries sandwich a sticky layer or component between two relative non-sticky layers such as dough. For example, a cinnamon roll is essentially a sticky cinnamon paste sandwiched between dough, which is then rolled over onto itself. When slicing a cinnamon roll, the cutting utensil enters and leaves the roll touching dough and not the cinnamon paste. The dough on the outside of the roll helps prevent the sticky paste inside from adhering to the cutting utensil, thereby increasing production efficiency. However, such a benefit is usually gained by sacrificing convenience when baking or reheating the end food product. For example, cinnamon rolls are not microwave friendly as the roll and the filling typically heat at very different rates resulting in an undesirable product for consumption.

### SUMMARY OF THE INVENTION

The present invention overcomes these and other deficiencies of the prior art by providing an automated assembly line technique that efficiently cuts and segregates, for example, dough having a sticky food substance on the top or outside. The cut and segregated pieces of dough with a sticky layer on top are assembled into a container as a “pull-apart” food item. The pull-apart food item may then be microwave heated relatively quickly and thoroughly without the areas of the item becoming dry or overheated.

In an embodiment of the invention, a food production assembly line system comprises: a divider for separating a food sheet into multiple longitudinal strips, and a non-stick cutter for cutting said multiple longitudinal strips into individual pieces, wherein said non-stick cutter cuts said multiple longitudinal strips substantially perpendicular to a longitudinal axis of said multiple longitudinal strips. A hopper may be included for applying a smear to a surface of said multiple longitudinal strips. The food sheet may be dough. The non-stick cutter may be an ultrasonic knife. The individual pieces with smear may be rectangular shaped. The assembly line system may further include a means for arranging a number of said individual pieces into a serving container such that contact between sticky smear on the top surfaces of said pieces is randomized.

In another embodiment of the invention, a food item assembly method comprises the steps of: separating a sheet of dough into multiple strips, applying a smear to a surface of said multiple strips, and cutting said multiple strips with applied smear into individual pieces. The method may further comprise the step of accumulating a number of said individual pieces into a container, wherein said step of accumulation is randomly performed such that contact between the smear surfaces of said individual pieces is reduced.

In yet another embodiment of the invention, a pull-apart food item comprises: multiple individual pieces of dough, and smear applied to at least one surface of each of said multiple individual pieces of dough. The multiple individual pieces of dough with applied smear are randomly arranged to reduce contact between smear surfaces and to provide interstitial space between the cooked food pieces. The pieces are pre-baked and frozen.

In yet another embodiment of the invention, a method for serving a pull-apart food item comprises the steps of: receiving a pull-apart food item, wherein said pull-apart food item comprises multiple individual pieces of dough and smear applied to a surface of each of said multiple individual pieces of dough, and heating said pull-apart food item to a serving temperature. The pull-apart food item is contained within a microwaveable serving cup in which the food item is also cooked.

An advantage of the present invention is realized in the use of an ultrasonic guillotine knife blade which prevents the unbaked dough pieces with added sticky layer from sticking to the knife resulting in clean cut ends of the pieces without an affinity for self adhesion until a second faster running conveyor belt can segregate the items. The technique is particularly advantageous when cutting and segregating small pieces.

An advantage also results from the random placement of small pieces into a container prior to baking. Random placement ensures that the majority of the small pieces will not touch one another fully at their sticky interfaces. The result after baking and reheating is the removal of the food from the container almost assuredly as individual small pieces for eating and not a large cluster of pieces stuck together.

The present invention involves the provision of a method of making a pull apart food product involving making a plurality of discrete food pieces utilizing flour and plasticizer. The pieces are placed in a container after having a coating applied to at least a portion of the exterior surfaces of the food pieces. The food pieces are cooked in a container and are shipped, stored and re-heated in the same container.

The present invention also involves the provision of a food product with food product including a container, a plurality of food pieces in the container and at least one coating on exterior surface portions of the food pieces. The food pieces are a flour based and are cooked. The food pieces are pull apart and are re-heatable by microwave radiation in the storage and cooking container.

The foregoing, and other features and advantages of the invention, will be apparent from the following, more particular description of the preferred embodiments of the invention, the accompanying figures, and the claims.

### BRIEF DESCRIPTION OF THE FIGURES

For a more complete understanding of the present invention, the objects and advantages thereof, reference is now made to the ensuing descriptions taken in connection with the accompanying figures briefly described as follows:

FIG. 1 illustrates an assembly line system for preparing a pull-apart food item according to an embodiment of the invention;

FIG. 2 illustrates pull-apart food items in a heatable serving cup resulting from the assembly line system according to an embodiment of the invention;

FIGS. 3A and 3B illustrate an automated system for randomly placing the food pieces in a heatable cup;

FIG. 4 illustrates an alternative strip cutting system as implemented for the assembly production of small pieces of food having a bulk stickiness.

FIG. 5 illustrates one form of food product contained in a container with the food product having an icing component on top of the flour based food pieces.

FIG. 6 is another embodiment of the present invention, showing the food pieces in a container with the food pieces containing particulates embedded within the individual food pieces.

FIG. 7 shows a still further embodiment of the present invention as seen from the top of the container with the container having an icing coating in the bottom of the container coating the bottom of the composite of food pieces.

FIG. 8 is a view of the food product seen in FIG. 7 but removed from the container and inverted to show the coating on the bottom of the composite of food pieces.

### DETAILED DESCRIPTION OF EMBODIMENTS

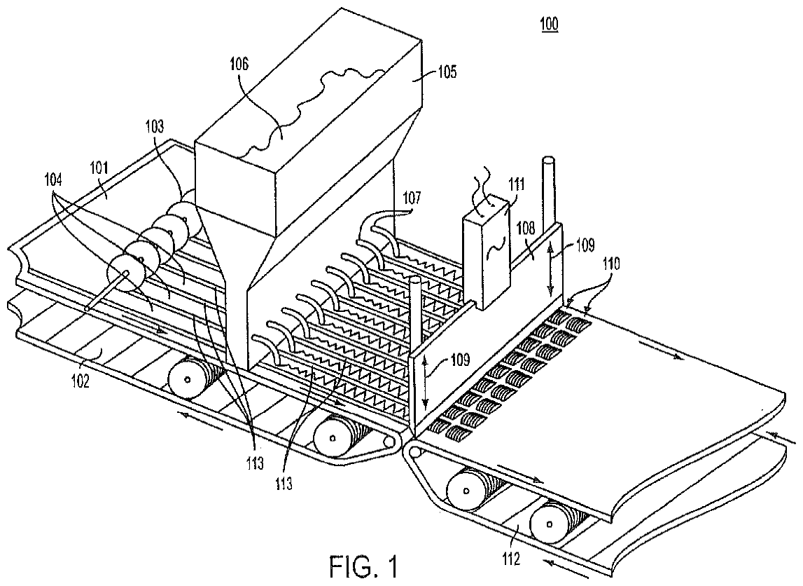

Embodiments of the present invention and their advantages may be understood by referring to FIGS. 1-4, wherein like reference numerals refer to like elements and are described in the context of preparing a “pull-apart” food item. Nonetheless, the improvements described herein are applicable to the preparation of any type of food item having a component which tends to stick or accumulate on conventional cutting, segregating, or slicing utensils.

The present invention is particularly well suited for preparing a pull-apart food item. A “pull-apart” food as used herein refers to a food item comprising a number of individual food pieces that although presented together as a whole may be easily separated from one another, i.e., pulled apart by hand or by a utensil such as fork after heating. For example, a pull-apart food may comprise a number of dough pieces covered with a cinnamon paste or smear on one side, e.g., the top surface, thereby forming a “cinnamon pull-apart.” By only applying the cinnamon smear to the top surface of each piece, the overall food product can be pre-baked and browned, frozen, and then re-heated again more evenly in a microwave oven.

FIG. 1 illustrates an assembly line 100 for preparing a pull-apart food item according to an embodiment of the invention. The assembly line 100 comprises: conveyor belts 102 and 112, a strip cutting system 103, a hopper 105, a plurality of dispensing tubes 107, an ultrasonic knife 108, and an ultrasonic transducer 111. In operation, a slab of dough 101 is moved on the conveyor belt 102, which is shown as moving clockwise in the figure. The strip cutting system 103 comprises multiple knives, preferably circular in shape in order to roll and cut the slab of dough 101 along the conveyor 102 into multiple parallel longitudinal strips 104 with enough space 113 between adjacent dough strips 104 to maintain separation once cut and moved past the knives 103. In an exemplary embodiment of the invention, the dough is cut into twelve strips 104 (although only nine are shown) of equal width by eleven knives 103 appropriately spaced apart.

Once past the strip cutting system 103 the strips pass under a hopper 105 containing a smear 106, which generally is sticky in nature, such as a cinnamon smear. The flow controlled dispensing tubes 107 attached to the bottom portion of the hopper 105 deposit the smear 106 on the top surface of each dough strip 104. The flow of the smear 106 and the linear speed of the conveyor 102 are maintained at predetermined values, the determination of which is apparent to one of ordinary skill in the art, to assure an evenly dispensed amount of the smear 106 on the top of each strip by the time the strips 104 arrive at the ultrasonic knife 108. Preferably, at least one of the surfaces of the pieces 110 is free or substantially free of coating 106 to provide a browning surface and an area where another coating may flow onto, provide interstitial space and an area capable of minor bonding to adjacent pieces if desired. The ultrasonic knife 108 is moved up and down, as indicated by the double headed arrows 109. The up and down cycle of the knife 108 is chosen such that a desired length of the resulting pieces of dough with their top sticky material 106 results. In an exemplary embodiment, the resulting pieces 110 are approximately one inch in length, one inch wide, and one inch thick.

The use of an ultrasonic knife alleviates the problem of the sticky smear 106 sticking to and accumulating on the blade of knife 108. Without the top laden sticky material on each strip the normal cutting action of the knife blade by itself would be sufficient to isolate each end portion of the pieces as properly floured dough generally does not stick to a metal knife blade. Likewise, if the smear 106 was not sticky it would not likely accumulate on the knife 108 when placed on top of the strips 104. However, because of the presence of a sticky smear 106 on top of the strips 104, repeated clean cuts of the pieces are foiled by eventual deposits of the sticky smear on the surface of the knife blade. This problem is alleviated by the incorporation of the ultrasonic transducer 111 attached to the blade of the knife 108. The ultrasonic vibration of the knife 108 effectively prevents the deposit of the sticky smear 106 on the knife, thereby resulting in clean straight end cuts as well as the elimination of any need to stop the assembly line 100 and clean the knife 108. Thus, fast and efficient production of the pull-apart constituents 110 is achieved. The use of the ultrasonic knife 108 also eliminates the existence of stringy filaments of sticky material between the food pieces and the knife and between the food pieces themselves.

In order to effect longitudinal separation between the cut pieces 110, the knife 108 is placed over a second conveyor belt 112 butted end-to-end with the first conveyor belt 102 according to an embodiment of the invention. The conveyor belt 112 is operated at a linear speed faster than that of the conveyor belt 102 resulting in a pulling apart of the pieces assuring no possible end-to-end self adhesion of neighboring food pieces 110. For example, the conveyor belt 112 may operate at a speed which is 20% faster than the speed of the conveyor belt 102.

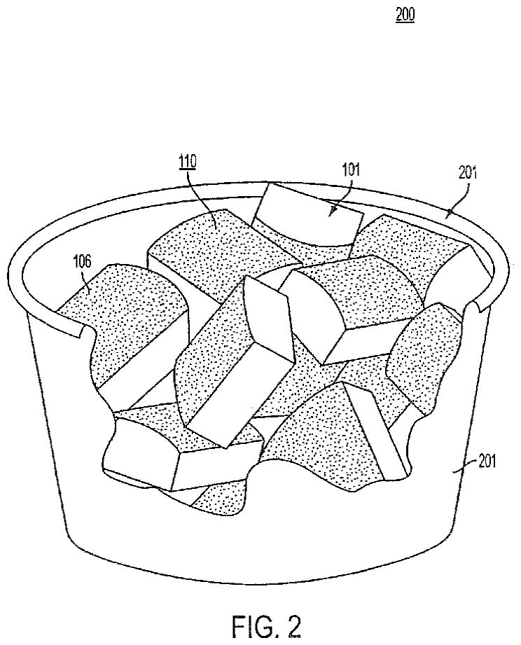

The cut food pieces 110 resulting from the described assembly line 100 are either manually and/or automatically placed into containers. FIG. 2 illustrates a container configuration 200 according to an embodiment of the invention. Particularly, the container configuration 200 comprises an individual serving cup 201 with a number of randomly placed pull-apart food items 110, each comprising dough 101 with a topside smear 106 resulting from the assembly line system 100.

The manual placement of the pieces 110 into the cup 201 involves the use of one or more persons removing the pieces 110 from the conveyor belt 112 and randomly placing them into the cup 201. In an exemplary embodiment of the invention, twelve pieces 110 are randomly placed into a cup to reduce contact between the sticky smear surfaces 106 of the pieces 110. It has been unexpectedly found through experiment that random and low amount of contact between the sticky smear surfaces 106 results in more efficient microwave heating of the overall food item.

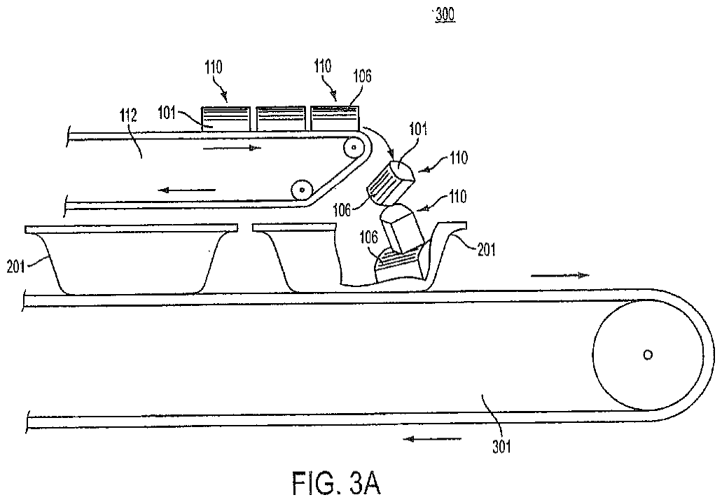

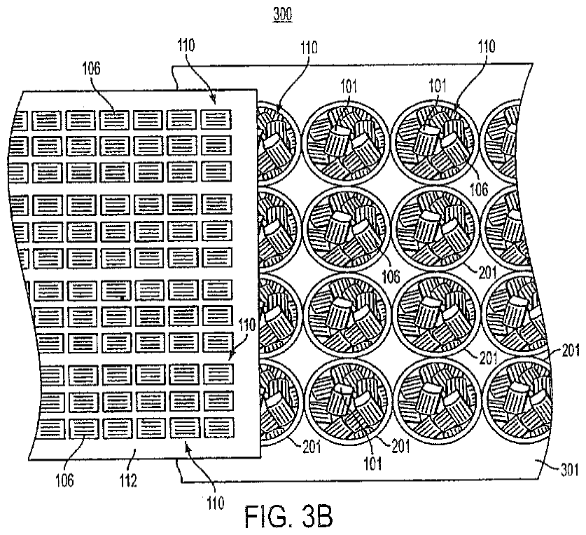

FIG. 3A and FIG. 3B illustrate an automated system 300 for randomly placing the food pieces in the cup 201 according to an embodiment of the invention. FIG. 3A illustrates a cross sectional side view of this system and FIG. 3B illustrates a top down view of the same system. The automated system 300 comprises a conveyor 301 wherein multiple cups 201 are placed and moved along such. Referring to FIG. 3A, one linear row of food pieces 110 are shown conveyed along on the conveyor 112. In reality there are more rows as shown in FIG. 3B, where twelve rows are shown for an exemplary case. The pieces 110 are allowed to fall under gravity off the conveyor 112 at its terminus and tumble randomly into the containers 201. Containers 201 are transported left to right by the conveyer 301 below conveyor 112 and the containers 201 are moved at a linear speed such that the food pieces fall into it from the right to left position thereby distributing stacked food pieces 110 over the inside volume of the container 201. One cut-away container 201 is shown in the process of being filled, but in reality a row of containers 201 perpendicular to the plane of the figure are simultaneously being filled as shown in the top down view of FIG. 3B. In the example shown, each container 201 in a row can accept up to 3 rows of food pieces 110 at a time and in this exemplary configuration be made to accept twelve pieces of randomly placed food items 110 in each container 201. FIG. 3A also shows that empty containers 201 are placed in a row along the conveyor belt 301. The filled containers 201 are either removed manually from the conveyor 301 or by automatic means such as, but not limited to a robotic arm.

In another embodiment, the automation may be accomplished through the use of a “pick and place” method. In this embodiment a replaceable pick much like a toothpick is mounted onto a robotic arm. The pick is stuck into the food piece 110, the food piece 110 then moved over the container 201, shaken loose, and allowed to randomly fall into the container. An electromechanical actuator or a similar system connected to the robotic arm causes this shaking action. Several robotic arms with such picks in place can be used to load several containers 201 simultaneously.

In an embodiment of the invention, the dough is prepared from a commercially available dough mix, cinnamon roll mix, or the like.

In an embodiment of the invention, the smear is prepared from a commercially available smear mix such as a cinnamon smear. One of ordinary skill in the art recognizes that a cinnamon smear is exemplary only. Other exemplary smears include, but are not limited to caramel, chocolate, grape, strawberry, orange, sugar, cream cheese, or even a combination thereof. In an alternative embodiment of the invention, a topping could be substituted for the smear. The topping may comprise one or more layers such as cheese, pepperoni, etc. as for the case of bite size pizza pieces.

In another embodiment of the invention, the container configuration 200 with pull-apart food items 110 contained therein is baked and then cooled in a blast freezer, and then shipped to a food establishment or restaurant. The container assembly 200 may include an outer box with a hinged lid into which the container 201 may be placed. The food establishment or restaurant reheats the pull-apart food item to a serving temperature, preferably using a microwave oven. Experimental results have shown that 12 pieces 110 within an individual serving cup 201 can be reheated to an adequate serving temperature within 14 seconds for an approximately 1000 watt microwave oven.

In an embodiment of the invention, baking occurs for ten to fourteen minutes in an oven heated to 325-375 degrees Fahrenheit. Icing may be applied after baking and before blast freezing.

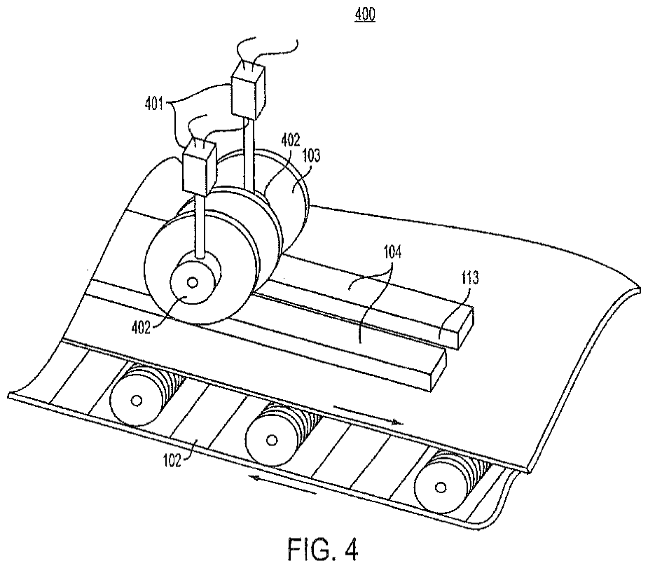

FIG. 4 illustrates an alternative strip cutting system 400 as implemented for the assembly production of small pieces of food having bulk stickiness. For food with bulk stickiness the sticking of the food to the strip cutting system blades becomes an added problem to the assembly production to that described for the food with a sticky film. To alleviate this problem the strip cutting system 103 is outfitted with ultrasonic transducers 401 in a similar fashion to the previously described guillotine knife. In the case of the strip cutting system 103, the ultrasonic transducers 401 would be attached to system support members 402 at the ends and in between the blades if needed. The ultrasonically driven strip cutting system would also assist in the cutting of bulk sticky food in which the inherent surface tension of the uncooked dough is inoperative and a space 113 between strips 104 still needs to be enacted.

The food pieces 110 are preferably cereal grained based comminuted material containing starch and protein and more preferably based on wheat flour. However, other cereal grains may be used, individually or in combination for example, corn, barley and rye. Wheat is desirable as a flour component because it contains gluten as a major protein and can be developed and yeast or chemically leavened to form a cellular structure in the cooked product. An effective wheat flour is General Mills Medallion, bleached, enriched, malted, code 249799 249894. A laminated or flaky cooked product may also be made. The food pieces 110 can be made from a dough, preferably a yeast or chemically leavened dough. The pieces may be made from a low water dough which may also be preferably leavened and when cooked provides a crumb structure, Cookie dough is a form of such a low water dough. A pie crust type dough may also be used which typically does not contain CO₂ producing leavening agents but may take on leavened characteristics from steam generated during cooking and may have a flaky cooked texture. Puff pastries and laminated pastries may also be used as food pieces 110. Pizza type crusts are a form of bread.

The methods for producing doughs are well known in the art. A typical high water dough has a flour content, on a dry weight basis, in the range of between about 45% and about 60% and preferably in the range of between about 47% and about 56%, plasticizer, includes at least one plasticizer, e.g., fat and water. Fat can be present in high water doughs in the range of between about 1% and about 15% and preferably in the range of between about 1% and about 13% and total water in the range of between about 35% and about 50% and more preferably in the range of between about 40% and about 48% by total weight of dough, i.e., flour and plasticizer. Sugar may be added to the dough in the range of between about 2% and about 12% and preferably in the range of between about 3.5% and about 10% by weight of flour, plasticizer and sugar. Doughs can be used to produce various types of products which are herein divided into two groups, for convenience, breads and sweet goods. Sweet goods tend to have a higher fat content and a higher sugar content than breads. There is no clear line of distinction between the two types of products. Breads, will have a flour content in the range of between about 50% and about 55%, the flour being on a dry weight basis, total water in the range of between about 43% and about 48%, fat in the range of between about 1% and about 3% by weight of flour, water and fat. Bread will typically also include a sugar and with the sugar included, the bread will have a flour content in the range of between about 48% and about 53%, the flour being on a dry weight basis, total water in the ran1ge of between about 42% and about 45%, fat in the range of between about 1% and about 3% and sugar in the range of between about 3.5% and about 6% by total weight of flour, water, fat and sugar. Sweet goods, have a flour content in the range of between about 46% and about 57%, the flour on a dry weight basis, total water in the range of between about 35% and about 45% and fat in the range of between about 3% and about 15% by weight of flour, water and fat. Sugar may also be provided in a sweet goods dough. The sweet goods dough will have flour in the range of between about 40% and about 55%, the flour on a dry weight basis, water in the range of between about 35% and about 42%, fat in the range of between about 2% and about 15% and sugar in the range of between about 5% and about 12% by weight of flour, total water, fat and sugar. When the dough is cooked, the water level of the cooked product will be lower than that of the dough product with the total water content being reduced in the range of between about 20% and about 35% of the total water present in the dough. When wheat is used, hard wheat or high protein, i.e., 10% or more protein, wheat flour may be used for developed doughs. Other ingredients may be added to the dough including leavening agent, dough conditioners, NFDM (non fat dry milk), whole or dried eggs, flavors, colorants, salt and the like depending upon the final product to be made. For doughs, it is preferred that the fat have an SFC (solids fat content) of about 11-19% at 88° F., 8-12% at 92° F. and about 5-8% at 104° F. and a Mettler drop point in the range of between about 105° F. and about 115° F. and preferably in the range of between about 108° F. and about 112° F. Bunge F217OLA NH shortening has been found effective. In the case of low water doughs, a soft wheat flour, low protein flour, i.e., less than about 10% protein, is preferred or other cereal grain based flour, as described above. Low water dough can be used to make products such as cookies and pie crust. Low water dough will typically have a flour content, on a dry weight basis in the range of between about 35% and about 75%, total water in the range of between about 18% and about 30% and fat in the range of between about 7% and about 45% by weight of combined flour, total water and fat. Pie crust typically does not contain any sugar while cookies do, both products being made from a low water dough. When sugar is added, to make a cookie or the like, the dough will contain flour, on a dry weight basis, in the range of between about 35% and about 65%, total water in the range of between about 15% and about 25%, fat in the range of between about 5% and about 15% and sugar in the range of between about 10% and about 35% by weight of total mixture of flour, sugar, water and fat. A crust type product, for example a pie crust type product, will typically have flour in the range of between about 35% and about 65%, on a dry weight basis, total water in the range of between about 15% and about 25% and fat in the range of between about 15% and about 45% by weight of flour, total water and fat. Typically, for pie crust type product the shortening or fat is cut into the flour rather than forming an intimate homogeneous mixture as is known in the art. Such cutting in of the fat provides a flaky texture.

For a puff pastry type product, an admixture of flour, water and shortening is provided with the admixture containing approximately 30% to about 48% by weight of flour on a dry weight basis, total water in a weight range of between about 25% and about 35% and fat in the range of between about 25% and about 40% by total weight of flour, water and fat. Typically, puff pastry does not include a chemical or yeast leavening system but can be given a leavened structure by air or steam produced during cooking. Danish and croissant type products are layered like a puff pastry but they are often leavened with yeast. The fat used in a puff pastry, includes both the fat included in the dough and the added roll in fat which is utilized to provide the flaky texture of the puff pastry as is known in the art.

In the cooking processes of the dough, water is lost and the leavener system is changed. Yeast is rendered non-viable by heat. In the case of chemically leavened doughs, leaveners have components that react to produce CO₂ and reaction products. During cooking a significant amount of water may be lost for bread like items, ⅓ of the total water may be lost. In the case of cookies and pie crusts, the final total water content is typically less than about 3% to give a dry or crisp texture. For doughs, a high protein flour is usually preferred with the protein content being at least about 10% of the flour on a dry weight basis. For low water doughs, soft wheat flour which is generally low protein flour is preferred with the flours having a protein content of less than about 10% on a dry weight basis. The ingredients for the flour based mixture are suitably mixed to form the appropriate plasticized mixture, the dough, with desired rheology to be self supporting and non-liquid at room temperature and during cooking. For high water doughs, the dough is developed to the proper degree of development usually peak development, as is known. The making of low water doughs may involve forming a relatively homogeneous plasticized mixture. However, sometimes in low water doughs, there are multiple discrete zones of fat and flour/water matrix to provide flaky layers in the cooked product. The flour and plasticizer are mixed to form the dough to produce an irregular crumb structure when cooked. Such mixing techniques are well known in the art.

The dough (plasticized flour mixture) is formed into discrete non-liquid self supporting uncooked food piece precursors, as for example, by the cutting method for the doughs described above. A surface application or coating of the smear components can be added prior to or after cutting of a quantity of the mixture into discrete pieces. As described above, the smear is applied prior to cutting wherein the smear is applied to the plasticized mixture preferably on one surface thereof. The smear may be a combination of fat and flavorings for example, a low SFC (at room temperature) fat which may include margarine or butter as components with flavorants such as cinnamon, sugar, etc. Some of the smear ingredients may be in particulate form, e.g. some of the sugar. The relative amounts of smear ingredients will be determined by taste and piece seperability considerations. The smear may also be a relatively viscous mixture of fat along with sugars and flavorants and a vicosifying or water binding ingredient to increase viscosity of the water if water is used. The smear may be a water based mixture such as fruit fillings, jellies and the like. The smear is of a sufficient viscosity and/or the surface of the food pieces to which it is applied may be coated, e.g., with fat to prevent the migration of the smear or some of the smear components into the food pieces prior to and preferably during cooking. At least a substantial portion of the applied smear preferably remains on or adjacent the exterior surface of the food pieces during the cooking process and prevents or reduces commingling of abutting pieces while preferably permitting some cohesion or adhesion bonding. Some cohesion is desired to provide pull apart pieces. An effective sweet goods smear contains: fat in the range of between about 25% and about 40% and preferably in the range of between about 30% and about 35%; total sugar in the range of between about 50% and about 70% and preferably in the range of between about 55% and about 65%; and other flavorants like cinnamon in the range of between about 2% and about 10% and preferably in the range of between about 3% and about 7% by total weight of smear. In a preferred embodiment, the total sugar in the smear coating is a combination of granulated sugar and brown sugar. The brown sugar is present in the range of between about 25% and about 30% of the smear coating and the granulated sugar is present in the range of between about 30% and about 35% by weight of the smear coating. The fat preferably has SFC value in the range of between about 8% and 15% at 80° F., and about 4% to 10% at 92° F. and about 1% to 6% at 104° F. and has a Mettler drop point in the range of between about 95° F. and 108° F. and preferably in the range of between about 99° and 105° F. A suitable fat is Bunge NH Table Grade Margarine sold as F582OLA. The sugar, or at least a substantial portion of the sugar is in crystalline or powdered form in the smear coating. In a preferred embodiment, the smear will have sweetener such as one or more sugars, like sucrose, dextrose (glucose), maltose and fructose (levulose) in crystalline or powdered form to help prevent bonding of the pieces during cooking and reheating. The smear may be applied by pressure dispensing, dispensing in a heated condition, “waterfall” coating, or extrusion of the smear. The smear may also be water based by binding the water with protein, pectin, or other suitable water binding agent.

The smear coating 106 is present on the cooked food pieces in an amount of at least about 30%, preferably in the range of between about 30% and about 65% and more preferably in the range of between about 45% grams and about 55% grams per by weight of cooked food pieces, i.e., the discrete flour based food pieces 110 which amounts have been found adequate to reduce the commingling of the discrete pieces together during cooking and reheating. In a preferred embodiment, the smear is present generally uniformly on at least a substantial portion of one surface of the discrete pieces or the sheet of dough before or after severing into the discrete pieces.

A second coating 150, e.g., a frosting, icing or savory coating may be utilized. Preferably, a substantial portion and more preferably at least a majority of the second coating resides on either the top or bottom surface 159, 158 respectively of the composite 155 of food pieces 110. In a preferred embodiment, the frosting can be used and can be either fat and/or water based and contain sugar and other flavors and/or colorants. The coating 150 may also include particulates 157 such as nut meats. The coating 150 may be applied at the point of use if desired but it is preferred that it be applied to the composite assembly 155 of food pieces 110 prior to delivery to the point of use. Preferably, the sugar is either sucrose, dextrose or fructose. Artificial sweeteners may also be used. Combinations of sweeteners may also be used and the sugar may be crystaline, powdered and/or dissolved. The frosting is, at room temperature, preferably a paste, i.e., not flowable on its own and can contain fat like margarine or butter fats in the amount of at least about 10% and preferably in the range of between about 15% and about 30% and can contain water in the range of between about 1% and about 20% on a total weight basis of the frosting components. Sugar can be present in the range of between about 40% and about 80% and more preferably in the range of between about 50% and about 65% by total weight of frosting. The fat may be a blend of vegetable oil, margarine or butter and vegetable shortening. The fat has an SFC of at least about 10 and preferably in the range of between about 12 and about 20 at 70° F. and a Mettler drop point of less than about 110° F. Some of the fat can include margarine and/or butter for taste purposes as well as appearance. Upon heating, the frosting 150 will have its viscosity reduced allowing it to run over the individual pieces for application thereto even though it is applied mainly to the top surface of the pieces within the container and remains as applied until heated. Frosting 150 is applied in the range of between about 10% and about 45%, preferably in the range of between about 25% and about 45%, and more preferably in the range of between about 30% and about 40% by weight of cooked food pieces. The total amount of the coatings 106, 150 is in the range of between about 55% and about 110%, preferably in the range of between about 70% and about 90% and most preferably in the range of between about 75% and about 85% by weight of cooked food pieces.

The cooked flour based food pieces, without coating, have an individual volume of at least about 8 cc, preferably in the range of between about 8 cc's and about 55 cc's and more preferably in the range of between about 25 cc's and about 35 cc's. The weight of each of the cooked pieces will be at least about 2 g, preferably in the range of between about 2 g and about 20 g and more preferably in the range of between about 5 g and about 10 g the total weight of the cooked pieces is in the range of between about 40 g and about 240 g, preferably in the range of between about 60 g and about 150 g and most preferably in the range of between about 70 g and about 100 g. From an upstream processing standpoint to make the individual food pieces, it has been found that rectangular pieces are effective to achieve random positioning in the containers, however, other shapes may be utilized, e.g., hexagons, discs, toroids, spheres, etc. Hexagons may be used effectively since they can be formed in a manner to substantially eliminate any dough web between cut pieces. If a scrap dough web or scrap pieces are formed during the food piece cutting step, this would require the removed material to be reworked in order to reduce waste. Because of the rheology of the uncooked dough pieces, they will remain generally discrete or individual from one another during the cooking process with the smear coating compound positioned between contacting surfaces assisting in maintaining separation, not commingling, of the pieces and where the pieces are cohered, may be easily separated. Additionally, the random placement of the discrete pieces in a cooking utensil helps reduce cohesion or adhesion between the pieces during cooking also resulting interstitial space between the pieces 110 thereby increasing the total exposed surface area of the composite 155.

The formed and coated uncooked pieces are placed in a cooking utensil, preferably a container that can also be used for storage, reheating and serving, for example, oven proof plastic, such as CPET (crystallized polyethylene terepthalate), paperboard, coated paperboard or other suitable materials that are preferably disposable if the product is to be served in a fast food restaurant. The container is ovenable and will withstand heating in an environment of at least about 250° F., preferably at least about 300° F., more preferably at least about 350° F. and most preferably at least about 425° F. The food pieces may be proofed if desired, prior to placing in the container or after placing in the container and prior to cooking. However, some proofing for proofed product is likely to occur during cooking.

While a sheet of dough is shown, it is to be understood, that the discrete pieces may be formed by an extrusion process and cut into discrete pieces upon exit from an extruder barrel.

If a leavened dough precursor product is used, the dough is proofed prior to cooking as is known in the art. Proofing is not required or needed for the production of some low water dough products although some “proofing” or expansion may occur during the cooking process from the evolution of steam. Leavening agents can also be added if desired. Typically, low water doughs utilize chemical leavening systems as are known in the art. Low water doughs may be used to make cookie and crust type cooked products and high water doughs may be used to make bread like including flaky pastry cooked products. The dough may be yeast leavened or chemically leavened as is known in the art. However, for flavor and aroma purposes, yeast leavening is preferred for high water dough. Multiple forms of leavening may be utilized simultaneously as is known in the art.

In a preferred embodiment, at least about 6 cooked pieces 110 of food and preferably between about 8 and about 16 food pieces 110 are contained in each container for reheating for an approximate, 4 ounce, 113 grams, total weight food product and about 2.5 ounces, 57 grams, of food pieces 110. The number of pieces per ounce of cooked food pieces is in the range of between about 3 and about 7 (about 0.1 to about 0.25 pieces per gram). The total weight of the cooked food pieces and coatings in a container is in the range of between about 80 g and about 340 g, preferably in the range of between about 80 g and about 200 g, more preferably in the range of between about 95 g and about 140 g and most preferably in the range of between about 110 g and about 130 g. The smear coating on the individual food pieces helps prevent cohesion of the pieces together during cooking and reheating. During reheating, the viscosity of the smear coating typically will decrease assisting in the ability to easily separate the pieces of food either using an eating utensil like a fork or the fingers. The thermal mass of each of the pieces with the coating(s) is small enough to reduce the chance of imparting an excess temperature sensation to a consumer's finger, mouth or the like. Heating of the packaged pieces can be with the clear overwrap in place or removed as is preferred for the individual product. The product may also have a quantity of frosting applied thereto for both aesthetic and taste purposes. Surprisingly, the flour based pieces do not toughen from microwave reheating. Microwave reheating times will vary by oven. Microwave ovens with a power rating of 1000-2000 watts may be used. The product may be reheated from a frozen or refrigerated state and the time to heat will change accordingly. Reheating can be accomplished in about 15 to 40 seconds in a 1000 watt microwave oven and in the range of between about 10 to 30 seconds in a 2000 watt microwave oven.

The cooked and coated pieces are delivered to a location for use, for example, a fast food restaurant in a container suitable for reheating of the product. In the case of the discrete pieces being cooked together within a container, the cooking container may be used as the shipping, storage and reheating container. The containers may be sealed with an overwrap or the like if desired, e.g., a heat resistant clear plastic shrink film or may be packaged in a respective outer container to at least cover the open top of the container. The cooked product is preferably stored in a frozen condition to help extend the shelf life of the products. Frozen means the storage temperature is below 32° F., preferably below about 10° F. and more preferably below about 0° F. However, refrigerated distribution may be used if desired. Refrigerated storage is typically between about 35° F. and about 42° F.

Preferably, the cooking of the food pieces is accomplished in a radiant heat oven and can be a forced convection oven. The preferred cooking temperature is in the range of between about 300° F. and about 425° F. and preferably in the range of between about 325° F. and about 375° F. The product is cooked sufficiently to set the structure and to impart the desired coloration to the exposed surface of the pieces. The product is preferably cooked in the serving/storage/reheating container. The cooked product may be sealed in the container. The cooked product may be overwrapped and sealed as described above and subsequently frozen or refrigerated for storage.

The dough food piece precursors are cooked sufficiently to set the structure of the product to be self supporting. The end product may be partially cooked or completely cooked as desired. Preferably, for fast food restaurant purposes, complete cooking is preferred in order to reduce the processing time at the restaurant. A convenient way of reheating, is to reheat the product by microwave heating. A low lossy, highly transmissive microwave compatible container is preferred. Susceptor materials may be used with the container if desired. The container 201 has a storage volume in the range of between about 140 cc's and about 900 cc's; and preferably in the range of between about 140 cc's, and about 350 cc's and more preferably in the range of between about 160 cc's and about 250 cc's. The weight of an empty container is in the range of about 5 g and about 20 g more preferably in the range of between about 5 g and about 10 g and most preferably in the range of between about 7 g and about 9 g. The depth of the container is such as to preferably hold 2-3 layers of food pieces. The container 201 will preferably contain multiple layers of randomly positioned food pieces. The layers may be either horizontally and/or vertically disposed and preferably both horizontally and vertically disposed. The structure of the discrete pieces with the smear and/or topping and/or icing present, the composite product looks like a unitary whole when in fact it is discrete pieces some of which may be lightly bound together, if at all. The final product will have the discrete food pieces generally loosely associated with one another in the container and may be lightly adhered or cohered, bound, together.

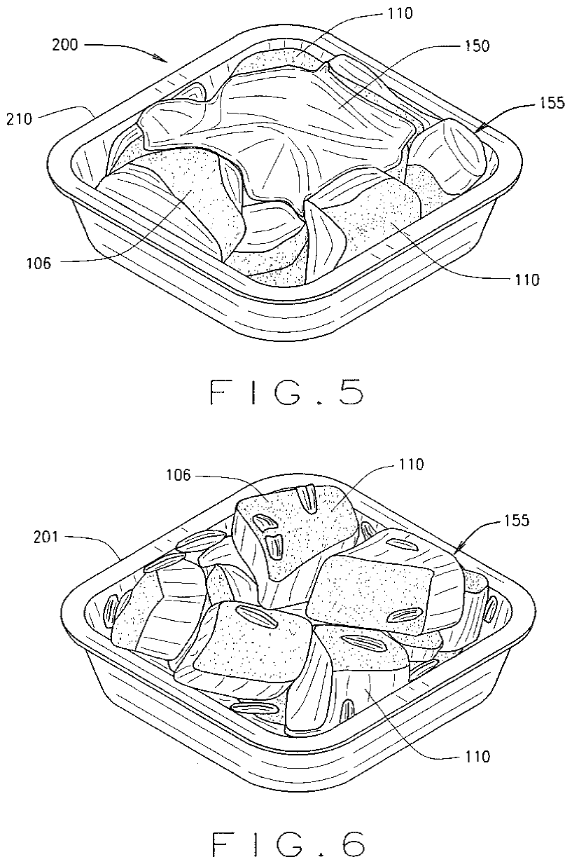

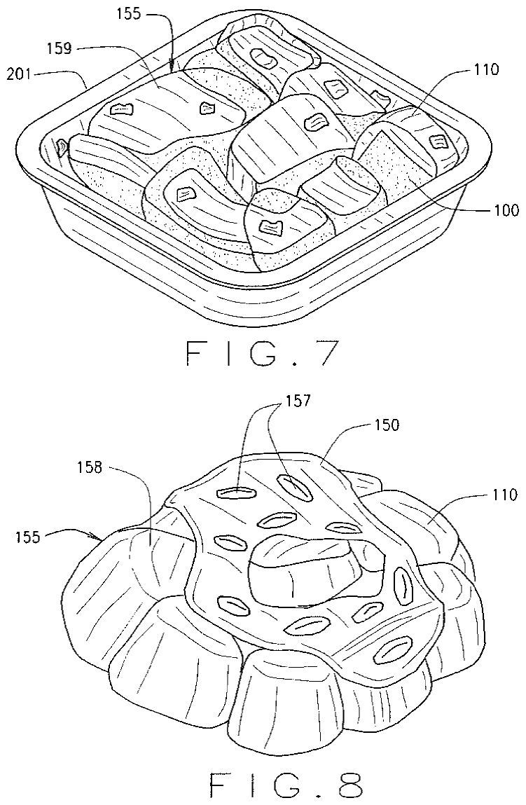

FIGS. 7, 8 shows a modified form of the invention. This figure shows a pecan roll execution. The pecan roll is formed from lightly bound together discrete food pieces 110 instead of the typical rolled form of pecan roll. The topping 150 is placed in the bottom of the container but eaten on the top of the product, FIG. 8, when the product is removed from the container 201 and inverted. The topping 150 typically includes brown sugar, water, some fat preferably in the form of a margarine or butter and is preferably caramel. The sugar may be provided as powdered or crystalline. Nut meats may also be added as particulates 157. Other food particulates can be used, e.g., fruit pieces, chocolate chips, etc. When warm, the viscosity of the non particulate portion of the topping is low enough to easily separate the discrete pieces. When inverted, the topping may run from the original bottom 158 toward the original top 159 of the combined discrete pieces of the food 155. The topping may bind the discrete pieces together at marginal edges but by keeping the quantity of topping at an appropriate amount, binding can be kept to a sufficiently low degree to still permit easy separation of the pieces allowing separation without significant tearing of the flour based pieces and excessive handling of the heated product. In a preferred embodiment, the caramel topping is present in an amount in the range of between about 10% and about 40% and preferably in the range of between about 20% and about 30% by weight of flour based cooked food pieces 110. In the form of the invention seen in FIGS. 7, 8 a substantial portion of the topping 150 and preferably a majority of the bottom surface 158. In the form of the invention shown in FIG. 5, a substantial portion of the topping 150 and preferably a majority of the topping 150 is on the surface 159.

The foregoing description of the product relates to sweet goods. The present invention can also be utilized for savory products as discussed also above, for example, a pizza like product with a tomato and/or cheesy and/or imitation cheese based smear/coating instead of a sweet type coating as described immediately above for the smear. Particulates, meats, vegetables, meat analogs and/or vegetable analogs, may also be provided on each of the pieces with the particulates being adhered to the flour based food pieces as with a tomato type coating or smear. A cheese smear can also be provided or an imitation cheese smear. The coatings would be provided in the above listed weight ranges.

The product of the present invention are food pieces made from a cereal grain based dough to which is applied a smear coating that is either fat and/or water based that inhibits the product from commingling together during cooking and/or reheating. The viscosity of the smear when heated is sufficient to permit easy separation of the discrete pieces. The pieces 110 as cooked, are soft and bread like with a cellular structure or flaky or can have a crumb structure in texture having a density of less than about 0.5 g/cm³ and preferably in the range of between about 0.2 g/cm³ and about 0.4 g/cm³ without smear, frosting or other coating or topping and are meant for reheating after cooking the product. The discrete pieces are formulated for consumption with an eating utensil capable of penetrating into or through the pieces for removal from the heating container. A main constituent of the food products is a cereal grain flour and the product is preferably cooked by heating in an air environment, as for example, baking. In one execution, the total external surface area of each of the discrete pieces is in the range of between about 20 cm² and about 80 cm² and preferably in the range of between about 35 cm² and about 65 cm². The thickness of the pieces which would be the smaller of the three transverse dimensions, which thickness is preferably in the range of between about 0.5 cm and about 4 cm more preferably in the range of between about 1 cm and about 3 cm and most preferably in the range of between about 1.5 cm and about 2.5 cm.

The food product and container, as described above, are combined to form a packaged food product especially adapted for single serve use and use in a fast food restaurant. The packaged food has cooked food pieces 110, at least one coating 106, 150, and container 201. The weight of empty container 201 is in the range of between about 5% and about 30% and preferably in the range of between about 10% and about 25% by weight of the cooked pieces 110. The weight of the empty container 201 is in the range of between about 2% and about 15% and preferably in the range of between about 5% and about 12% by weight of the food pieces 110 and total weight of coatings 106 and/or 150. The total weight of the coatings 106 and/or 150 is in the range of between about 50% and about 150% and preferably in the range of between about 75% and about 125% by weight of the cooked pieces 110.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A method of forming a flour-based pull-apart food product, comprising:
forming at least one strip of substantially uncooked dough, the at least one strip of substantially uncooked dough being made of flour;
applying a coating to only a portion of the at least one strip of substantially uncooked dough, the coating comprising fat in a range of between 25% and 40% by weight of the coating and sugar in a range of between about 50% and 70% by weight of the coating;
cutting the at least one strip of substantially uncooked dough with the coating applied thereon to form a plurality of substantially uncooked flour-based discrete food pieces with coating portions of the coating on only portions of the substantially uncooked discrete dough pieces;
dropping the substantially uncooked flour-based discrete dough pieces each with the coating portion thereon into a container so that the substantially uncooked flour-based discrete dough pieces each with the coating portion thereon fall into random positions within the container, the random positions of the substantially uncooked discrete dough pieces each with the coating portion thereon causing the substantially uncooked discrete dough pieces to contact at first contact points where there is dough-to-dough contact and no coating therebetween and to contact at second contact points where there is coating therebetween, the container being oven-heatable to a temperature of at least about 250° F. and microwaveable;
substantially cooking the substantially uncooked flour-based discrete dough pieces each with the coating portion thereon in the container to form at least substantially cooked food pieces each with the coating portion thereon with self-supporting structure, the coating having a viscosity during the substantially cooking to cause at least some of the coating portion to remain on the portion of each of the substantially uncooked flour-based discrete dough pieces and to prevent cohesion of adjacent discrete dough pieces at the second contact points having coating therebetween, the substantially cooking causing the adjacent discrete dough pieces at the first contact points to cohere and the adjacent discrete dough pieces at second contact points not to cohere; and
re-heating the at least substantially cooked food pieces each with the coating portion thereon in the container to finish cooking the at least substantially cooked food pieces each with the coating portion thereon to form the flour-based pull-apart food product, the flour-based pull-apart food product having fully cooked flour-based adjacent food pieces that pull apart by tearing of fully cooked dough at the first contact points where there is dough-to-dough contact and by reduced or no tearing at the second contact points where there is coating therebetween.

2. The method of claim 1, wherein the substantially uncooked discrete dough pieces include wheat flour and yeast.

3. The method of claim 1, further comprising applying a sweet topping.

4. The method of claim 1, further comprising applying a savory topping.

5. The method of claim 1, wherein the substantially uncooked discrete dough pieces have a cellular structure.

6. The method of claim 1, wherein the substantially uncooked discrete dough pieces have a crumb structure.

7. The method of claim 1, wherein the substantially uncooked discrete dough pieces have a flaky structure.

8. The method of claim 1, further comprising applying a topping including fat having a Mettler drop point of less than about 110° F.

9. The method of claim 1, wherein the coating includes fat having a Mettler drop point in a range of between about 95° F. and about 108° F.

10. The method of claim 1, wherein the container is constructed of at least one of paperboard and polymeric material capable of cooking the substantially uncooked discrete dough pieces therein at a temperature of at least about 300° F.

11. A method of forming a flour-based pull-apart food product, comprising:
forming at least one strip of substantially uncooked dough, the at least one strip of substantially uncooked dough being made of flour;
cutting the at least one strip of substantially uncooked dough to form a plurality of substantially uncooked flour-based discrete food pieces;
applying a coating to only a portion of the a plurality of substantially uncooked flour-based discrete food pieces to form substantially uncooked flour-based discrete dough pieces each with a coating portion of the coating thereon, the coating comprising fat in a range of between 25% and 40% by weight of the coating and sugar in a range of between about 50% and 70% by weight of the coating;
dropping the substantially uncooked flour-based discrete dough pieces each with the coating portion thereon into a container so that the substantially uncooked flour-based discrete dough pieces each with the coating portion thereon fall into random positions within the container, the random positions of the substantially uncooked discrete dough pieces each with the coating portion thereon causing the substantially uncooked discrete dough pieces to contact at first contact points where there is dough-to-dough contact and no coating therebetween and to contact at second contact points where there is coating therebetween, the container being oven-heatable to a temperature of at least about 250° F. and microwaveable;
substantially cooking the substantially uncooked flour-based discrete dough pieces each with the coating portion thereon in the container to form at least substantially cooked food pieces each with the coating portion thereon with self-supporting structure, the coating having a viscosity during the substantially cooking to cause at least some of the coating portion to remain on the portion of each of the substantially uncooked flour-based discrete dough pieces and to prevent cohesion of adjacent discrete dough pieces at the second contact points having coating therebetween, the substantially cooking causing the adjacent discrete dough pieces at the first contact points to cohere and the adjacent discrete dough pieces at second contact points not to cohere; and
re-heating the at least substantially cooked food pieces each with the coating portion thereon in the container to finish cooking the at least substantially cooked food pieces each with the coating portion thereon to form the flour-based pull-apart food product, the flour-based pull-apart food product having fully cooked flour-based adjacent food pieces that pull apart by tearing of fully cooked dough at the first contact points where there is dough-to-dough contact and by reduced or no tearing at the second contact points where there is coating therebetween.

12. The method of claim 11, wherein the substantially uncooked discrete dough pieces include wheat flour and yeast.

13. The method of claim 11, further comprising applying a sweet topping.

14. The method of claim 11, further comprising applying a savory topping.

15. The method of claim 11, wherein the substantially uncooked discrete dough pieces have a cellular structure.

16. The method of claim 11, wherein the substantially uncooked discrete dough pieces have a crumb structure.

17. The method of claim 11, wherein the substantially uncooked discrete dough pieces have a flaky structure.

18. The method of claim 11, further comprising applying a topping including fat having a Mettler drop point of less than about 110° F.

19. The method of claim 11, wherein the coating includes fat having a Mettler drop point in a range of between about 95° F. and about 108° F.

20. The method of claim 11, wherein the container is constructed of at least one of paperboard and polymeric material capable of cooking the substantially uncooked discrete dough pieces therein at a temperature of at least about 300° F.
